(19) United States
(12) Patent Application Publication
(10) Pub. No.: US 2024/0211046 A1
(43) Pub. Date: Jun. 27, 2024

(54) Vision-Based Road Feel Enhancement in Vehicles

(71) Applicant: Nissan North America, Inc., Franklin, TN (US)

(72) Inventors: Mark Bailey, Seattle, WA (US); Erik St. Gray, Tacoma, WA (US); Kevin Kochever, San Bruno, CA (US); Stefan Witwicki, San Carlos, CA (US)

(21) Appl. No.: 18/145,680

(22) Filed: Dec. 22, 2022

(51) Int. Cl. G06F 3/01; B62D 6/00; G06N 3/0475; G06N 3/094; G06T 17/05

(52) U.S. Cl. CPC G06F 3/016; B62D 6/008; G06N 3/0475; G06N 3/094; G06T 17/05

(57) ABSTRACT

Road feel is created in a vehicle that has a steer-by-wire system using image data obtained from one or more cameras on the vehicle and image data obtained from a light detection and ranging (LIDAR) sensor. A generative adversarial network (GAN) machine learning (ML) model is used to determine a road surface based on the image data from the one or more cameras and the image data from the LIDAR sensor. Haptic vibrations are generated based on the determined road surface to create the road feel using one or more motors on various vehicle components.

### TECHNICAL FIELD

This disclosure relates to vehicle operational management and steer-by-wire enhancements.

### BACKGROUND

Vehicles are typically equipped with a steering column and electronic steering. Vibrations from the road are transferred from the wheels to the steering wheel via the steering column to produce a road feel for the driver. Some vehicles may be equipped with steer-by-wire systems that do not have a mechanical connection between the steering wheel and the wheels of the vehicle. Instead, the steering configuration uses cables that transmit electronic signals to the vehicle's gear. Since there is no mechanical connection between the steering wheel and the wheels of the vehicle, feedback from the wheels of the vehicle (i.e., road feel) is typically lost.

Typical solutions to improve road feel in vehicles configured with steer-by-wire systems use electronic sensing through the wheels of the vehicle. These solutions focus on detecting a signal through the wheels of the vehicle, and transmitting that signal to the steering wheel. The vibrations carried through to the steering wheel require the steering wheel to be turned, since a dead road feel is produced when the steering wheel is on-center. This is a problem since on-center is the most typical location for the steering wheel. In addition, expensive hardware, such as hybrid hydraulic/electronic steering systems are needed to collect accurate road feel information that can be transmitted to the steering wheel.

### SUMMARY

Disclosed herein are aspects, features, elements, implementations, and embodiments of vision-based road feel enhancement in vehicles.

An aspect of the disclosed embodiments is a method for creating a road feel in a vehicle. The method includes obtaining first image data from a camera. The method includes obtaining second image data from a light detection and ranging (LIDAR) sensor. The method includes determining a road surface based on the first image data and the second image data using a generative adversarial network (GAN) machine learning (ML) model. The method includes generating haptic vibrations based on the determined road surface to create a road feel.

An aspect of the disclosed embodiments is a vehicle that is configured to create a road feel. The vehicle may include a camera, a LIDAR sensor, and a processor. The camera may be configured to capture first image data associated with a road surface. The LIDAR sensor may be configured to capture second image data associated with the road surface. The processor may be configured to determine the road surface based on the first image data and the second image data based on a GAN ML model. The processor may be configured to generate haptic vibrations based on the determined road surface to create a road feel.

An aspect of the disclosed embodiments is a non-transitory computer-readable medium that includes instructions stored in a memory. The instructions may be executed by a processor and may cause the processor to obtain first image data from the camera. The processor may obtain second image data from a LIDAR sensor. The processor may determine a road surface based on the first image data and the second image data using a GAN ML model. The processor may transmit a signal to a haptic motor on a vehicle component to create a road feel. The signal may be based on the determined road surface.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which:

FIG. 1 is a diagram of an example of a vehicle in which the aspects, features, and elements disclosed herein may be implemented;

FIG. 2 is a diagram of an example of a portion of a vehicle transportation and communication system in which the aspects, features, and elements disclosed herein may be implemented;

FIG. 3 is a diagram of a portion of a vehicle transportation network in accordance with this disclosure;

FIG. 4 is a diagram of an example of an autonomous vehicle operational management system in accordance with embodiments of this disclosure;

FIG. 5 is a flow diagram of an example of a method for training a vision-based model for haptic road feel;

FIG. 6 is a flow diagram of an example of a method for generating a haptic road feel using a vision-based model.

FIG. 7 is a flow diagram of another example of a method for generating a haptic road feel using a vision-based model.

FIG. 8 is a flow diagram of another example of a method for generating a haptic road feel using a vision-based model.

FIG. 9 is a flow diagram of an example of a method for training a generative adversarial network (GAN) model for haptic road feel.

FIG. 10 is a flow diagram of an example of a method for generating a three-dimensional (3D) terrain model for haptic road feel.

FIG. 11 is a flow diagram of another example of a method for generating a 3D terrain model for haptic road feel.

### DETAILED DESCRIPTION

Vehicles, such as autonomous vehicles, or semi-autonomous vehicles, may be equipped with a steer-by-wire system. The steer-by-wire system may be configured to enhance road feel. The road feel may be enhanced using image data, such as image data obtained from one or more cameras, image data obtained from a light detection and ranging (LIDAR) sensor, or both. A machine learning (ML) model, such as a generative adversarial network (GAN) model may be used to generate haptic vibrations to match the image data to simulate the road feel.

Although described herein with reference to an autonomous vehicle, the methods and apparatus described herein may be implemented in any vehicle capable of autonomous or semi-autonomous operation. Although described with reference to a vehicle transportation network, the method and apparatus described herein may include the autonomous vehicle operating in any area navigable by the vehicle.

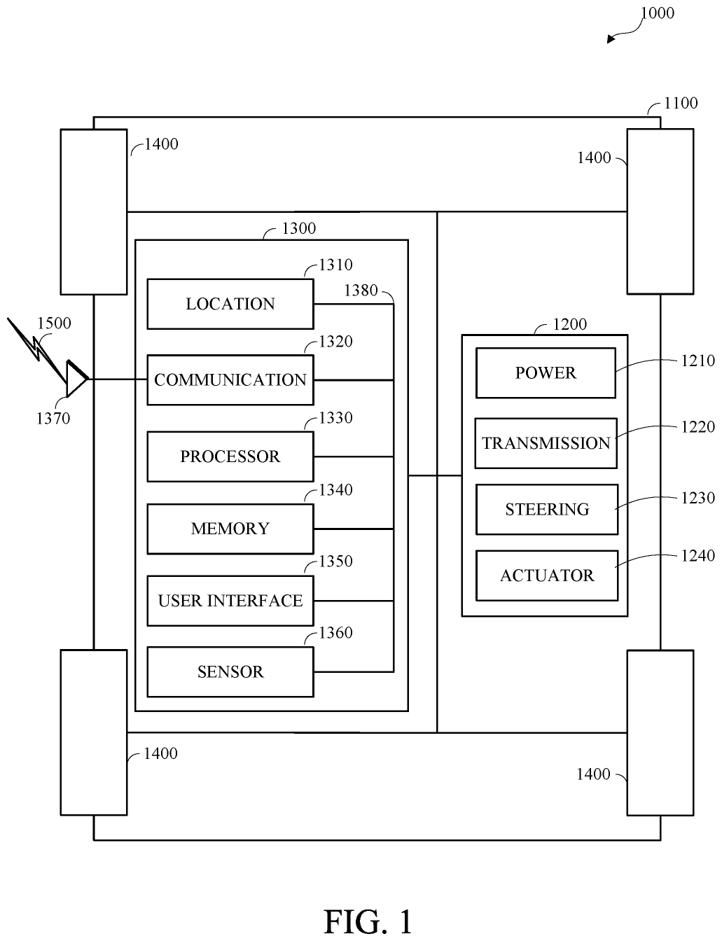

FIG. 1 is a diagram of an example of a vehicle in which the aspects, features, and elements disclosed herein may be implemented. As shown, a vehicle 1000 includes a chassis 1100, a powertrain 1200, a controller 1300, and wheels 1400. Although the vehicle 1000 is shown as including four wheels 1400 for simplicity, any other propulsion device or devices, such as a propeller or tread, may be used. In FIG. 1, the lines interconnecting elements, such as the powertrain 1200, the controller 1300, and the wheels 1400, indicate that information, such as data or control signals, power, such as electrical power or torque, or both information and power, may be communicated between the respective elements. For example, the controller 1300 may receive power from the powertrain 1200 and may communicate with the powertrain 1200, the wheels 1400, or both, to control the vehicle 1000, which may include accelerating, decelerating, steering, or otherwise controlling the vehicle 1000.

As shown, the powertrain 1200 includes a power source 1210, a transmission 1220, a steering unit 1230, and an actuator 1240. Other elements or combinations of elements of a powertrain, such as a suspension, a drive shaft, axles, or an exhaust system may be included. Although shown separately, the wheels 1400 may be included in the powertrain 1200.

The power source 1210 may include an engine, a battery, or a combination thereof. The power source 1210 may be any device or combination of devices operative to provide energy, such as electrical energy, thermal energy, or kinetic energy. For example, the power source 1210 may include an engine, such as an internal combustion engine, an electric motor, or a combination of an internal combustion engine and an electric motor, and may be operative to provide kinetic energy as a motive force to one or more of the wheels 1400. The power source 1210 may include a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 may receive energy, such as kinetic energy, from the power source 1210, and may transmit the energy to the wheels 1400 to provide a motive force. The transmission 1220 may be controlled by the controller 1300 the actuator 1240 or both. The steering unit 1230 may be controlled by the controller 1300 the actuator 1240 or both and may control the wheels 1400 to steer the vehicle. The actuator 1240 may receive signals from the controller 1300 and may actuate or control the power source 1210, the transmission 1220, the steering unit 1230, or any combination thereof to operate the vehicle 1000.

As shown, the controller 1300 may include a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and the processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof may be integrated in one or more electronic units, circuits, or chips.

The processor 1330 may include any device or combination of devices capable of manipulating or processing a signal or other information now-existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

The memory 1340 may include any tangible non-transitory computer-usable or computer-readable medium, capable of, for example, containing, storing, communicating, or transporting machine readable instructions, or any information associated therewith, for use by or in connection with the processor 1330. The memory 1340 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The communication interface 1370 may be a wireless antenna, as shown, a wired communication port, an optical communication port, or any other wired or wireless unit capable of interfacing with a wired or wireless electronic communication medium 1500. Although FIG. 1 shows the communication interface 1370 communicating via a single communication link, a communication interface may be configured to communicate via multiple communication links. Although FIG. 1 shows a single communication interface 1370, a vehicle may include any number of communication interfaces.

The communication unit 1320 may be configured to transmit or receive signals via a wired or wireless electronic communication medium 1500, such as via the communication interface 1370. Although not explicitly shown in FIG. 1, the communication unit 1320 may be configured to transmit, receive, or both via any wired or wireless communication medium, such as radio frequency (RF), ultraviolet (UV), visible light, fiber optic, wireline, or a combination thereof. Although FIG. 1 shows a single communication unit 1320 and a single communication interface 1370, any number of communication units and any number of communication interfaces may be used. In some embodiments, the communication unit 1320 may include a dedicated short-range communications (DSRC) unit, an on-board unit (OBU), or a combination thereof.

The location unit 1310 may determine geolocation information, such as longitude, latitude, elevation, direction of travel, or speed, of the vehicle 1000. For example, the location unit may include a global positioning system (GPS) unit, such as a Wide Area Augmentation System (WAAS) enabled National Marine-Electronics Association (NMEA) unit, a radio triangulation unit, or a combination thereof. The location unit 1310 can be used to obtain information that represents, for example, a current heading of the vehicle 1000, a current position of the vehicle 1000 in two or three dimensions, a current angular orientation of the vehicle 1000, or a combination thereof.

The user interface 1350 may include any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 1350 may be operatively coupled with the processor 1330, as shown, or with any other element of the controller 1300. Although shown as a single unit, the user interface 1350 may include one or more physical units. For example, the user interface 1350 may include an audio interface for performing audio communication with a person and a touch display for performing visual and touch-based communication with the person. The user interface 1350 may include multiple displays, such as multiple physically separate units, multiple defined portions within a single physical unit, or a combination thereof.

The sensor 1360 may include one or more sensors, such as an array of sensors, which may be operable to provide information that may be used to control the vehicle. The sensors 1360 may provide information regarding current operating characteristics of the vehicle 1000. The sensor 1360 can include, for example, a speed sensor, acceleration sensors, a steering angle sensor, traction-related sensors, braking-related sensors, steering wheel position sensors, eye tracking sensors, seating position sensors, one or more cameras, a LIDAR sensor, or any sensor, or combination of sensors, operable to report information regarding some aspect of the current dynamic situation of the vehicle 1000.

The sensor 1360 may include one or more sensors operable to obtain information regarding the physical environment surrounding the vehicle 1000. For example, one or more sensors may detect road geometry and features, such as lane lines, and obstacles, such as fixed obstacles, vehicles, and pedestrians. The sensor 1360 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 1360 and the location unit 1310 may be a combined unit.

Although not shown separately, the vehicle 1000 may include a trajectory controller. For example, the controller 1300 may include the trajectory controller. The trajectory controller may be operable to obtain information describing a current state of the vehicle 1000 and a route planned for the vehicle 1000, and, based on this information, to determine and optimize a trajectory for the vehicle 1000. In some embodiments, the trajectory controller may output signals operable to control the vehicle 1000 such that the vehicle 1000 follows the trajectory that is determined by the trajectory controller. For example, the output of the trajectory controller can be an optimized trajectory that may be supplied to the powertrain 1200, the wheels 1400, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 1400 may be a steered wheel, which may be pivoted to a steering angle under control of the steering unit 1230, a propelled wheel, which may be torqued to propel the vehicle 1000 under control of the transmission 1220, or a steered and propelled wheel that may steer and propel the vehicle 1000. The steering unit 1230 may be a steer-by-wire system that does not have a mechanical connection to a steered wheel. In an example where the steering unit 1230 is a steer-by wire system, the steer-by-wire system is configured to transmit digital signals to the steered wheel to adjust the steering angle of the steered wheel.

Although not shown in FIG. 1, a vehicle may include units, or elements, not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

The vehicle 1000 may be an autonomous vehicle controlled autonomously, without direct human intervention, to traverse a portion of a vehicle transportation network. Although not shown separately in FIG. 1, an autonomous vehicle may include an autonomous vehicle control unit, which may perform autonomous vehicle routing, navigation, and control. The autonomous vehicle control unit may be integrated with another unit of the vehicle. For example, the controller 1300 may include the autonomous vehicle control unit.

The autonomous vehicle control unit may control or operate the vehicle 1000 to traverse a portion of the vehicle transportation network in accordance with current vehicle operation parameters. The autonomous vehicle control unit may control or operate the vehicle 1000 to perform a defined operation or maneuver, such as parking the vehicle. The autonomous vehicle control unit may generate a route of travel from an origin, such as a current location of the vehicle 1000, to a destination based on vehicle information, environment information, vehicle transportation network data representing the vehicle transportation network, or a combination thereof, and may control or operate the vehicle 1000 to traverse the vehicle transportation network in accordance with the route. For example, the autonomous vehicle control unit may output the route of travel to the trajectory controller, and the trajectory controller may operate the vehicle 1000 to travel from the origin to the destination using the generated route.

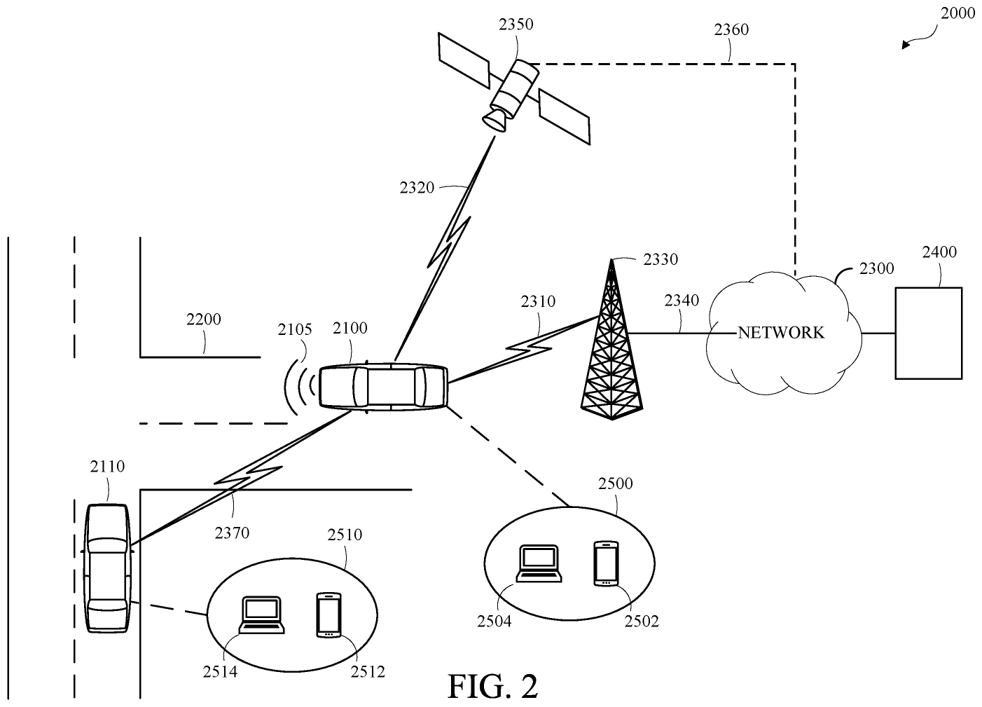

FIG. 2 is a diagram of an example of a portion of a vehicle transportation and communication system in which the aspects, features, and elements disclosed herein may be implemented. The vehicle transportation and communication system 2000 may include one or more vehicles 2100/2110, such as the vehicle 1000 shown in FIG. 1, which may travel via one or more portions of one or more vehicle transportation networks 2200, and may communicate via one or more electronic communication networks 2300. Although not explicitly shown in FIG. 2, a vehicle may traverse an area that is not expressly or completely included in a vehicle transportation network, such as an off-road area.

The electronic communication network 2300 may be, for example, a multiple access system and may provide for communication, such as voice communication, data communication, video communication, messaging communication, or a combination thereof, between the vehicle 2100/2110 and one or more communication devices 2400. For example, a vehicle 2100/2110 may receive information, such as information representing the vehicle transportation network 2200, from a communication device 2400 via the network 2300.

In some embodiments, a vehicle 2100/2110 may communicate via a wired communication link (not shown), a wireless communication link 2310/2320/2370, or a combination of any number of wired or wireless communication links. For example, as shown, a vehicle 2100/2110 may communicate via a terrestrial wireless communication link 2310, via a non-terrestrial wireless communication link 2320, or via a combination thereof. The terrestrial wireless communication link 2310 may include an Ethernet link, a serial link, a Bluetooth link, an infrared (IR) link, an ultraviolet (UV) link, or any link capable of providing for electronic communication.

A vehicle 2100/2110 may communicate with another vehicle 2100/2110. For example, a host, or subject, vehicle (HV) 2100 may receive one or more automated inter-vehicle messages, such as a basic safety message (BSM), from a remote, or target, vehicle (RV) 2110, via a direct communication link 2370, or via a network 2300. For example, the remote vehicle 2110 may broadcast the message to host vehicles within a defined broadcast range, such as 300 meters. In some embodiments, the host vehicle 2100 may receive a message via a third party, such as a signal repeater (not shown) or another remote vehicle (not shown). A vehicle 2100/2110 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 2100 may communicate with the communications network 2300 via an access point 2330. The access point 2330, which may include a computing device, may be configured to communicate with a vehicle 2100, with a communication network 2300, with one or more communication devices 2400, or with a combination thereof via wired or wireless communication links 2310/2340. For example, the access point 2330 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit in FIG. 2, an access point may include any number of interconnected elements.

The vehicle 2100 may communicate with the communications network 2300 via a satellite 2350, or other non-terrestrial communication device. The satellite 2350, which may include a computing device, may be configured to communicate with a vehicle 2100, with a communication network 2300, with one or more communication devices 2400, or with a combination thereof via one or more communication links 2320/2360. Although shown as a single unit in FIG. 2, a satellite may include any number of interconnected elements.

An electronic communication network 2300 may be any type of network configured to provide for voice, data, or any other type of electronic communication. For example, the electronic communication network 2300 may include a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the HyperText Transport Protocol (HTTP), or a combination thereof. Although shown as a single unit in FIG. 2, an electronic communication network may include any number of interconnected elements.

The vehicle 2100 may identify a portion or condition of the vehicle transportation network 2200. For example, the vehicle 2100 may include one or more on-vehicle sensors 2105, such as sensor 1360 shown in FIG. 1, which may include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 2200. The sensor data may include lane line data, remote vehicle location data, or both.

The vehicle 2100 may traverse a portion or portions of one or more vehicle transportation networks 2200 using information communicated via the network 2300, such as information representing the vehicle transportation network 2200, information identified by one or more on-vehicle sensors 2105, or a combination thereof.

Although, for simplicity, FIG. 2 shows two vehicles 2100, 2110, one vehicle transportation network 2200, one electronic communication network 2300, and one communication device 2400, any number of vehicles, networks, or computing devices may be used. The vehicle transportation and communication system 2000 may include devices, units, or elements not shown in FIG. 2. Although the vehicle 2100 is shown as a single unit, a vehicle may include any number of interconnected elements.

Although the vehicle 2100 is shown communicating with the communication device 2400 via the network 2300, the vehicle 2100 may communicate with the communication device 2400 via any number of direct or indirect communication links. For example, the vehicle 2100 may communicate with the communication device 2400 via a direct communication link, such as a Bluetooth communication link.

In some embodiments, a vehicle 2100/2210 may be associated with an entity 2500/2510, such as a driver, operator, or owner of the vehicle. In some embodiments, an entity 2500/2510 associated with a vehicle 2100/2110 may be associated with one or more personal electronic devices 2502/2504/2512/2514, such as a smartphone 2502/2512 or a computer 2504/2514. In some embodiments, a personal electronic device 2502/2504/2512/2514 may communicate with a corresponding vehicle 2100/2110 via a direct or indirect communication link. Although one entity 2500/2510 is shown as associated with one vehicle 2100/2110 in FIG. 2, any number of vehicles may be associated with an entity and any number of entities may be associated with a vehicle.

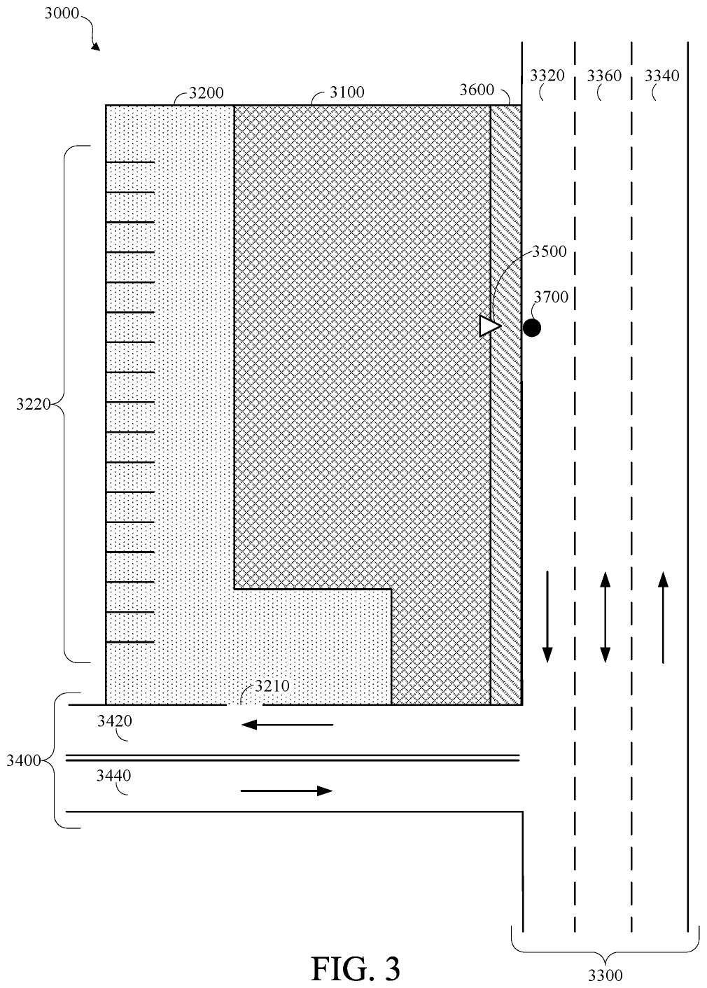

FIG. 3 is a diagram of a portion of a vehicle transportation network in accordance with this disclosure. A vehicle transportation network 3000 may include one or more unnavigable areas 3100, such as a building, one or more partially navigable areas, such as parking area 3200, one or more navigable areas, such as roads 3300/3400, or a combination thereof. In some embodiments, an autonomous vehicle, such as the vehicle 1000 shown in FIG. 1, one of the vehicles 2100/2110 shown in FIG. 2, a semi-autonomous vehicle, or any other vehicle implementing autonomous driving, may traverse a portion or portions of the vehicle transportation network 3000.

The vehicle transportation network 3000 may include one or more interchanges 3210 between one or more navigable, or partially navigable, areas 3200/3300/3400. For example, the portion of the vehicle transportation network 3000 shown in FIG. 3 includes an interchange 3210 between the parking area 3200 and road 3400. The parking area 3200 may include parking slots 3220.

A portion of the vehicle transportation network 3000, such as a road 3300/3400, may include one or more lanes 3320/3340/3360/3420/3440 and may be associated with one or more directions of travel, which are indicated by arrows in FIG. 3.

A vehicle transportation network, or a portion thereof, such as the portion of the vehicle transportation network 3000 shown in FIG. 3, may be represented as vehicle transportation network data. For example, vehicle transportation network data may be expressed as a hierarchy of elements, such as markup language elements, which may be stored in a database or file. For simplicity, the figures herein depict vehicle transportation network data representing portions of a vehicle transportation network as diagrams or maps; however, vehicle transportation network data may be expressed in any computer-usable form capable of representing a vehicle transportation network, or a portion thereof. The vehicle transportation network data may include vehicle transportation network control information, such as direction of travel information, speed limit information, toll information, grade information, such as inclination or angle information, surface material information, aesthetic information, defined hazard information, or a combination thereof.

The vehicle transportation network may be associated with, or may include, a pedestrian transportation network. For example, FIG. 3 includes a portion 3600 of a pedestrian transportation network, which may be a pedestrian walkway. Although not shown separately in FIG. 3, a pedestrian navigable area, such as a pedestrian crosswalk, may correspond with a navigable area, or a partially navigable area, of a vehicle transportation network.

A portion, or a combination of portions, of the vehicle transportation network may be identified as a point of interest or a destination. For example, the vehicle transportation network data may identify a building, such as the unnavigable area 3100, and the adjacent partially navigable parking area 3200 as a point of interest, a vehicle may identify the point of interest as a destination, and the vehicle may travel from an origin to the destination by traversing the vehicle transportation network. Although the parking area 3200 associated with the unnavigable area 3100 is shown as adjacent to the unnavigable area 3100 in FIG. 3, a destination may include, for example, a building and a parking area that is physically or geospatially non-adjacent to the building.

Identifying a destination may include identifying a location for the destination, which may be a discrete uniquely identifiable geolocation. For example, the vehicle transportation network may include a defined location, such as a street address, a postal address, a vehicle transportation network address, a GPS address, or a combination thereof for the destination.

A destination may be associated with one or more entrances, such as the entrance 3500 shown in FIG. 3. The vehicle transportation network data may include defined entrance location information, such as information identifying a geolocation of an entrance associated with a destination.

A destination may be associated with one or more docking locations, such as the docking location 3700 shown in FIG. 3. A docking location 3700 may be a designated or undesignated location or area in proximity to a destination at which an autonomous vehicle may stop, stand, or park such that docking operations, such as passenger loading or unloading, may be performed.

The vehicle transportation network data may include docking location information, such as information identifying a geolocation of one or more docking locations 3700 associated with a destination. Although not shown separately in FIG. 3, the docking location information may identify a type of docking operation associated with a docking location 3700. For example, a destination may be associated with a first docking location for passenger loading and a second docking location for passenger unloading. Although an autonomous vehicle may park at a docking location, a docking location associated with a destination may be independent and distinct from a parking area associated with the destination.

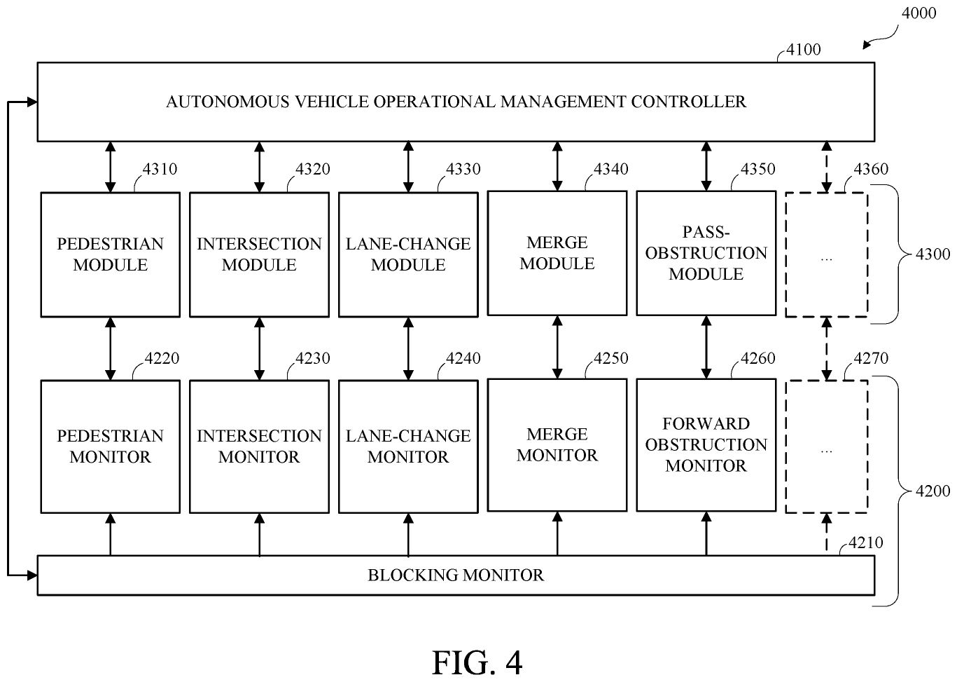

FIG. 4 is a diagram of an example of an autonomous vehicle operational management system 4000 in accordance with embodiments of this disclosure. The autonomous vehicle operational management system 4000 may be implemented in an autonomous vehicle, such as the vehicle 1000 shown in FIG. 1, one of the vehicles 2100/2110 shown in FIG. 2, a semi-autonomous vehicle, or any other vehicle implementing autonomous driving.

The autonomous vehicle may traverse a vehicle transportation network, or a portion thereof, which may include traversing distinct vehicle operational scenarios. A distinct vehicle operational scenario may include any distinctly identifiable set of operative conditions that may affect the operation of the autonomous vehicle within a defined spatiotemporal area, or operational environment, of the autonomous vehicle. For example, a distinct vehicle operational scenario may be based on a number or cardinality of roads, road segments, or lanes that the autonomous vehicle may traverse within a defined spatiotemporal distance. In another example, a distinct vehicle operational scenario may be based on one or more traffic control devices that may affect the operation of the autonomous vehicle within a defined spatiotemporal area, or operational environment, of the autonomous vehicle. In another example, a distinct vehicle operational scenario may be based on one or more identifiable rules, regulations, or laws that may affect the operation of the autonomous vehicle within a defined spatiotemporal area, or operational environment, of the autonomous vehicle. In another example, a distinct vehicle operational scenario may be based on one or more identifiable external objects that may affect the operation of the autonomous vehicle within a defined spatiotemporal area, or operational environment, of the autonomous vehicle.

For simplicity and clarity, similar vehicle operational scenarios may be described herein with reference to vehicle operational scenario types or classes. A type or class of a vehicle operation scenario may refer to a defined pattern or a defined set of patterns of the scenario. For example, intersection scenarios may include the autonomous vehicle traversing an intersection, pedestrian scenarios may include the autonomous vehicle traversing a portion of the vehicle transportation network that includes, or is within a defined proximity of, one or more pedestrians, such as wherein a pedestrian is crossing, or approaching, the expected path of the autonomous vehicle; lane-change scenarios may include the autonomous vehicle traversing a portion of the vehicle transportation network by changing lanes; merge scenarios may include the autonomous vehicle traversing a portion of the vehicle transportation network by merging from a first lane to a merged lane; pass-obstruction scenarios may include the autonomous vehicle traversing a portion of the vehicle transportation network by passing an obstacle or obstruction. Although pedestrian vehicle operational scenarios, intersection vehicle operational scenarios, lane-change vehicle operational scenarios, merge vehicle operational scenarios, and pass-obstruction vehicle operational scenarios are described herein, any other vehicle operational scenario or vehicle operational scenario type may be used.

As shown in FIG. 4, the autonomous vehicle operational management system 4000 includes an autonomous vehicle operational management controller 4100 (AVOMC), operational environment monitors 4200, and operation control evaluation modules 4300.

The AVOMC 4100, or another unit of the autonomous vehicle, may control the autonomous vehicle to traverse the vehicle transportation network, or a portion thereof. Controlling the autonomous vehicle to traverse the vehicle transportation network may include monitoring the operational environment of the autonomous vehicle, identifying or detecting distinct vehicle operational scenarios, identifying candidate vehicle control actions based on the distinct vehicle operational scenarios, controlling the autonomous vehicle to traverse a portion of the vehicle transportation network in accordance with one or more of the candidate vehicle control actions, or a combination thereof.

The AVOMC 4100 may receive, identify, or otherwise access, operational environment data representing an operational environment for the autonomous vehicle, or one or more aspects thereof. The operational environment of the autonomous vehicle may include a distinctly identifiable set of operative conditions that may affect the operation of the autonomous vehicle within a defined spatiotemporal area of the autonomous vehicle, within a defined spatiotemporal area of an identified route for the autonomous vehicle, or a combination thereof. For example, operative conditions that may affect the operation of the autonomous vehicle may be identified based on sensor data, vehicle transportation network data, route data, or any other data or combination of data representing a defined or determined operational environment for the vehicle.

The operational environment data may include vehicle information for the autonomous vehicle, such as information indicating a geospatial location of the autonomous vehicle, information correlating the geospatial location of the autonomous vehicle to information representing the vehicle transportation network, a route of the autonomous vehicle, a speed of the autonomous vehicle, an acceleration state of the autonomous vehicle, passenger information of the autonomous vehicle, or any other information about the autonomous vehicle or the operation of the autonomous vehicle. The operational environment data may include information representing the vehicle transportation network proximate to an identified route for the autonomous vehicle, such as within a defined spatial distance, such as 300 meters, of portions of the vehicle transportation network along the identified route, which may include information indicating the geometry of one or more aspects of the vehicle transportation network, information indicating a condition, such as a surface condition, of the vehicle transportation network, or any combination thereof. The operational environment data may include information representing the vehicle transportation network proximate to the autonomous vehicle, such as within a defined spatial distance of the autonomous vehicle, such as 300 meters, which may include information indicating the geometry of one or more aspects of the vehicle transportation network, information indicating a condition, such as a surface condition, of the vehicle transportation network, or any combination thereof. The operational environment data may include information representing external objects within the operational environment of the autonomous vehicle, such as information representing pedestrians, non-human animals, non-motorized transportation devices, such as bicycles or skateboards, motorized transportation devices, such as remote vehicles, or any other external object or entity that may affect the operation of the autonomous vehicle.

Aspects of the operational environment of the autonomous vehicle may be represented within respective distinct vehicle operational scenarios. For example, the relative orientation, trajectory, expected path, of external objects may be represented within respective distinct vehicle operational scenarios. In another example, the relative geometry of the vehicle transportation network may be represented within respective distinct vehicle operational scenarios.

As an example, a first distinct vehicle operational scenario may correspond to a pedestrian crossing a road at a crosswalk, and a relative orientation and expected path of the pedestrian, such as crossing from left to right for crossing from right to left, may be represented within the first distinct vehicle operational scenario. A second distinct vehicle operational scenario may correspond to a pedestrian crossing a road by jaywalking, and a relative orientation and expected path of the pedestrian, such as crossing from left to right for crossing from right to left, may be represented within the second distinct vehicle operational scenario.

The autonomous vehicle may traverse multiple distinct vehicle operational scenarios within an operational environment, which may be aspects of a compound vehicle operational scenario. The autonomous vehicle operational management system 4000 may operate or control the autonomous vehicle to traverse the distinct vehicle operational scenarios subject to defined constraints, such as safety constraints, legal constraints, physical constraints, user acceptability constraints, or any other constraint or combination of constraints that may be defined or derived for the operation of the autonomous vehicle.

The AVOMC 4100 may monitor the operational environment of the autonomous vehicle, or defined aspects thereof. Monitoring the operational environment of the autonomous vehicle may include identifying and tracking external objects, identifying distinct vehicle operational scenarios, or a combination thereof. For example, the AVOMC 4100 may identify and track external objects with the operational environment of the autonomous vehicle. Identifying and tracking the external objects may include identifying spatiotemporal locations of respective external objects, which may be relative to the autonomous vehicle, identifying one or more expected paths for respective external objects, which may include identifying a speed, a trajectory, or both, for an external object. For simplicity and clarity, descriptions of locations, expected locations, paths, expected paths, and the like herein may omit express indications that the corresponding locations and paths refer to geospatial and temporal components; however, unless expressly indicated herein, or otherwise unambiguously clear from context, the locations, expected locations, paths, expected paths, and the like described herein may include geospatial components, temporal components, or both. Monitor the operational environment of the autonomous vehicle may include using operational environment data received from the operational environment monitors 4200.

The operational environment monitors 4200 may include scenario-agnostic monitors, scenario-specific monitors, or a combination thereof. A scenario-agnostic monitor, such as a blocking monitor 4210, may monitor the operational environment of the autonomous vehicle, generate operational environment data representing aspects of the operational environment of the autonomous vehicle, and output the operational environment data to one or more scenario-specific monitor, the AVOMC 4100, or a combination thereof. A scenario-specific monitor, such as a pedestrian monitor 4220, an intersection monitor 4230, a lane-change monitor 4240, a merge monitor 4250, or a forward obstruction monitor 4260, may monitor the operational environment of the autonomous vehicle, generate operational environment data representing scenario-specific aspects of the operational environment of the autonomous vehicle, and output the operational environment data to one or more scenario-specific operation control evaluation modules 4300, the AVOMC 4100, or a combination thereof. For example, the pedestrian monitor 4220 may be an operational environment monitor for monitoring pedestrians, the intersection monitor 4230 may be an operational environment monitor for monitoring intersections, the lane-change monitor 4240 may be an operational environment monitor for monitoring lane-changes, the merge monitor 4250 may be an operational environment monitor for merges, and the forward obstruction monitor 4260 may be an operational environment monitor for monitoring forward obstructions. An operational environment monitor 4270 is shown using broken lines to indicate that the autonomous vehicle operational management system 4000 may include any number of operational environment monitors 4200. In an example, the operational environment monitor 4270 may be a road surface monitor for monitoring a surface of the road.

An operational environment monitor 4200 may receive, or otherwise access, operational environment data, such as operational environment data generated or captured by one or more sensors of the autonomous vehicle, vehicle transportation network data, vehicle transportation network geometry data, route data, or a combination thereof. For example, the pedestrian monitor 4220 may receive, or otherwise access, information, such as sensor data, which may indicate, correspond to, or may otherwise be associated with, one or more pedestrians in the operational environment of the autonomous vehicle. An operational environment monitor 4200 may associate the operational environment data, or a portion thereof, with the operational environment, or an aspect thereof, such as with an external object, such as a pedestrian, a remote vehicle, or an aspect of the vehicle transportation network geometry.

An operational environment monitor 4200 may generate, or otherwise identify, information representing one or more aspects of the operational environment, such as with an external object, such as a pedestrian, a remote vehicle, or an aspect of the vehicle transportation network geometry, which may include filtering, abstracting, or otherwise processing the operational environment data. An operational environment monitor 4200 may output the information representing the one or more aspects of the operational environment to, or for access by, the AVOMC 4100, such by storing the information representing the one or more aspects of the operational environment in a memory, such as the memory 1340 shown in FIG. 1, of the autonomous vehicle accessible by the AVOMC 4100, sending the information representing the one or more aspects of the operational environment to the AVOMC 4100, or a combination thereof. An operational environment monitor 4200 may output the operational environment data to one or more elements of the autonomous vehicle operational management system 4000, such as the AVOMC 4100. Although not shown in FIG. 4, a scenario-specific operational environment monitor 4220, 4230, 4240, 4250, 4260 may output operational environment data to a scenario-agnostic operational environment monitor, such as the blocking monitor 4210.

The pedestrian monitor 4220 may correlate, associate, or otherwise process the operational environment data to identify, track, or predict actions of one or more pedestrians. For example, the pedestrian monitor 4220 may receive information, such as sensor data, from one or more sensors, which may correspond to one or more pedestrians, the pedestrian monitor 4220 may associate the sensor data with one or more identified pedestrians, which may include may identifying a direction of travel, a path, such as an expected path, a current or expected velocity, a current or expected acceleration rate, or a combination thereof for one or more of the respective identified pedestrians, and the pedestrian monitor 4220 may output the identified, associated, or generated pedestrian information to, or for access by, the AVOMC 4100.

The intersection monitor 4230 may correlate, associate, or otherwise process the operational environment data to identify, track, or predict actions of one or more remote vehicles in the operational environment of the autonomous vehicle, to identify an intersection, or an aspect thereof, in the operational environment of the autonomous vehicle, to identify vehicle transportation network geometry, or a combination thereof. For example, the intersection monitor 4230 may receive information, such as sensor data, from one or more sensors, which may correspond to one or more remote vehicles in the operational environment of the autonomous vehicle, the intersection, or one or more aspects thereof, in the operational environment of the autonomous vehicle, the vehicle transportation network geometry, or a combination thereof, the intersection monitor 4230 may associate the sensor data with one or more identified remote vehicles in the operational environment of the autonomous vehicle, the intersection, or one or more aspects thereof, in the operational environment of the autonomous vehicle, the vehicle transportation network geometry, or a combination thereof, which may include may identifying a current or expected direction of travel, a path, such as an expected path, a current or expected velocity, a current or expected acceleration rate, or a combination thereof for one or more of the respective identified remote vehicles, and intersection monitor 4230 may output the identified, associated, or generated intersection information to, or for access by, the AVOMC 4100.

The lane-change monitor 4240 may correlate, associate, or otherwise process the operational environment data to identify, track, or predict actions of one or more remote vehicles in the operational environment of the autonomous vehicle, such as information indicating a slow or stationary remote vehicle along the expected path of the autonomous vehicle, to identify one or more aspects of the operational environment of the autonomous vehicle, such as vehicle transportation network geometry in the operational environment of the autonomous vehicle, or a combination thereof geospatially corresponding to a lane-change operation. For example, the lane-change monitor 4240 may receive information, such as sensor data, from one or more sensors, which may correspond to one or more remote vehicles in the operational environment of the autonomous vehicle, one or more aspects of the operational environment of the autonomous vehicle in the operational environment of the autonomous vehicle or a combination thereof geospatially corresponding to a lane-change operation, the lane-change monitor 4240 may associate the sensor data with one or more identified remote vehicles in the operational environment of the autonomous vehicle, one or more aspects of the operational environment of the autonomous vehicle or a combination thereof geospatially corresponding to a lane-change operation, which may include may identifying a current or expected direction of travel, a path, such as an expected path, a current or expected velocity, a current or expected acceleration rate, or a combination thereof for one or more of the respective identified remote vehicles, and the lane-change monitor 4240 may output the identified, associated, or generated lane-change information to, or for access by, the AVOMC 4100.

The merge monitor 4250 may correlate, associate, or otherwise process the operational environment information to identify, track, or predict actions of one or more remote vehicles in the operational environment of the autonomous vehicle, to identify one or more aspects of the operational environment of the autonomous vehicle, such as vehicle transportation network geometry in the operational environment of the autonomous vehicle, or a combination thereof geospatially corresponding to a merge operation. For example, the merge monitor 4250 may receive information, such as sensor data, from one or more sensors, which may correspond to one or more remote vehicles in the operational environment of the autonomous vehicle, one or more aspects of the operational environment of the autonomous vehicle in the operational environment of the autonomous vehicle or a combination thereof geospatially corresponding to a merge operation, the merge monitor 4250 may associate the sensor data with one or more identified remote vehicles in the operational environment of the autonomous vehicle, one or more aspects of the operational environment of the autonomous vehicle or a combination thereof geospatially corresponding to a merge operation, which may include may identifying a current or expected direction of travel, a path, such as an expected path, a current or expected velocity, a current or expected acceleration rate, or a combination thereof for one or more of the respective identified remote vehicles, and the merge monitor 4250 may output the identified, associated, or generated merge information to, or for access by, the AVOMC 4100.

The forward obstruction monitor 4260 may correlate, associate, or otherwise process the operational environment information to identify one or more aspects of the operational environment of the autonomous vehicle geospatially corresponding to a forward pass-obstruction operation. For example, the forward obstruction monitor 4260 may identify vehicle transportation network geometry in the operational environment of the autonomous vehicle; the forward obstruction monitor 4260 may identify one or more obstructions or obstacles in the operational environment of the autonomous vehicle, such as a slow or stationary remote vehicle along the expected path of the autonomous vehicle or along an identified route for the autonomous vehicle; and the forward obstruction monitor 4260 may identify, track, or predict actions of one or more remote vehicles in the operational environment of the autonomous vehicle. The forward obstruction monitor 4250 may receive information, such as sensor data, from one or more sensors, which may correspond to one or more remote vehicles in the operational environment of the autonomous vehicle, one or more aspects of the operational environment of the autonomous vehicle in the operational environment of the autonomous vehicle or a combination thereof geospatially corresponding to a forward pass-obstruction operation, the forward obstruction monitor 4250 may associate the sensor data with one or more identified remote vehicles in the operational environment of the autonomous vehicle, one or more aspects of the operational environment of the autonomous vehicle or a combination thereof geospatially corresponding to the forward pass-obstruction operation, which may include may identifying a current or expected direction of travel, a path, such as an expected path, a current or expected velocity, a current or expected acceleration rate, or a combination thereof for one or more of the respective identified remote vehicles, and the forward obstruction monitor 4250 may output the identified, associated, or generated forward obstruction information to, or for access by, the AVOMC 4100.

The blocking monitor 4210 may receive operational environment data representing an operational environment, or an aspect thereof, for the autonomous vehicle. The blocking monitor 4210 may determine a respective probability of availability, or corresponding blocking probability, for one or more portions of the vehicle transportation network, such as portions of the vehicle transportation network proximal to the autonomous vehicle, which may include portions of the vehicle transportation network corresponding to an expected path of the autonomous vehicle, such as an expected path identified based on a current route of the autonomous vehicle. A probability of availability, or corresponding blocking probability, may indicate a probability or likelihood that the autonomous vehicle may traverse a portion of, or spatial location within, the vehicle transportation network safely, such as unimpeded by an external object, such as a remote vehicle or a pedestrian. The blocking monitor 4210 may determine, or update, probabilities of availability continually or periodically. The blocking monitor 4210 may communicate probabilities of availability, or corresponding blocking probabilities, to the AVOMC 4100.

The AVOMC 4100 may identify one or more distinct vehicle operational scenarios based on one or more aspects of the operational environment represented by the operational environment data. For example, the AVOMC 4100 may identify a distinct vehicle operational scenario in response to identifying, or based on, the operational environment data indicated by one or more of the operational environment monitors 4200. The distinct vehicle operational scenario may be identified based on route data, sensor data, or a combination thereof. For example, the AVOMC 4100 may identifying one or multiple distinct vehicle operational scenarios corresponding to an identified route for the vehicle, such as based on map data corresponding to the identified route, in response to identifying the route. Multiple distinct vehicle operational scenarios may be identified based on one or more aspects of the operational environment represented by the operational environment data. For example, the operational environment data may include information representing a pedestrian approaching an intersection along an expected path for the autonomous vehicle, and the AVOMC 4100 may identify a pedestrian vehicle operational scenario, an intersection vehicle operational scenario, or both.

The AVOMC 4100 may instantiate respective instances of one or more of the operation control evaluation modules 4300 based on one or more aspects of the operational environment represented by the operational environment data. The operation control evaluation modules 4300 may include scenario-specific operation control evaluation modules (SSOCEMs), such as a pedestrian-SSOCEM 4310, an intersection-SSOCEM 4320, a lane-change-SSOCEM 4330, a merge-SSOCEM 4340, a pass-obstruction-SSOCEM 4350, or a combination thereof. A SSOCEM 4360 is shown using broken lines to indicate that the autonomous vehicle operational management system 4000 may include any number of SSOCEMs 4300. For example, the SSOCEM 4360 may be a road surface-SSOCEM. For example, the AVOMC 4100 may instantiate an instance of a SSOCEM 4300 in response to identifying a distinct vehicle operational scenario. The AVOMC 4100 may instantiate multiple instances of one or more SSOCEMs 4300 based on one or more aspects of the operational environment represented by the operational environment data. For example, the operational environment data may indicate two pedestrians in the operational environment of the autonomous vehicle and the AVOMC 4100 may instantiate a respective instance of the pedestrian-SSOCEM 4310 for each pedestrian based on one or more aspects of the operational environment represented by the operational environment data.

The SSOCEM 4360 may include an assign preference indicator module, a create scenario-specific operational control evaluation model module, a solve scenario-specific operational control evaluation model module, a policy module, or any combination thereof. An assign preference indicator module may be configured to assign a preference indicator to each vehicle control action. The preference indicator may be a reward value. The reward value may be a positive integer, for example, when a performed vehicle control action is successful. The reward value may be a negative integer, for example, when a performed vehicle control action is unsuccessful or is overridden by a user. In some examples, the preference indicator may be assigned based on the input. In some examples, the preference indicator may be a change in a buffer value associated with one or more objectives. In some examples, the preference indicator may be an ordering of the objectives.

A create scenario-specific operational control evaluation model module may be configured to determine a scenario-specific operational control evaluation model. The scenario-specific operational control evaluation model may be based on the objectives and associated performance indicators.

A solve scenario-specific operational control evaluation model module may be configured to solve the scenario-specific operational control evaluation model. The policy module may be configured to update a multi-objective policy based on the solved scenario-specific operational control evaluation model.

The AVOMC 4100 may send the operational environment data, or one or more aspects thereof, to another unit of the autonomous vehicle, such as the blocking monitor 4210 or one or more instances of the SSOCEMs 4300. For example, the AVOMC 4100 may communicate the probabilities of availability, or corresponding blocking probabilities, received from the blocking monitor 4210 to respective instantiated instances of the SSOCEMs 4300. The AVOMC 4100 may store the operational environment data, or one or more aspects thereof, such as in a memory, such as the memory 1340 shown in FIG. 1, of the autonomous vehicle.

Controlling the autonomous vehicle to traverse the vehicle transportation network may include identifying candidate vehicle control actions based on the distinct vehicle operational scenarios, controlling the autonomous vehicle to traverse a portion of the vehicle transportation network in accordance with one or more of the candidate vehicle control actions, or a combination thereof. For example, the AVOMC 4100 may receive one or more candidate vehicle control actions from respective instances of the SSOCEMs 4300. The AVOMC 4100 may identify a vehicle control action from the candidate vehicle control actions, and may control the vehicle, or may provide the identified vehicle control action to another vehicle control unit, to traverse the vehicle transportation network in accordance with the vehicle control action.

A vehicle control action may indicate a vehicle control operation or maneuver, such as accelerating, decelerating, turning, stopping, or any other vehicle operation or combination of vehicle operations that may be performed by the autonomous vehicle in conjunction with traversing a portion of the vehicle transportation network. For example, an ‘advance’ vehicle control action may include slowly inching forward a short distance, such as a few inches or a foot; an ‘accelerate’ vehicle control action may include accelerating a defined acceleration rate, or at an acceleration rate within a defined range; a ‘decelerate’ vehicle control action may include decelerating a defined deceleration rate, or at a deceleration rate within a defined range; a ‘maintain’ vehicle control action may include maintaining current operational parameters, such as by maintaining a current velocity, a current path or route, or a current lane orientation; and a ‘proceed’ vehicle control action may include beginning or resuming a previously identified set of operational parameters. Although some vehicle control actions are described herein, other vehicle control actions may be used.

A vehicle control action may include one or more performance metrics. For example, a ‘stop’ vehicle control action may include a deceleration rate as a performance metric. In another example, a ‘proceed’ vehicle control action may expressly indicate route or path information, speed information, an acceleration rate, or a combination thereof as performance metrics, or may expressly or implicitly indicate that a current or previously identified path, speed, acceleration rate, or a combination thereof may be maintained. A vehicle control action may be a compound vehicle control action, which may include a sequence, combination, or both of vehicle control actions. For example, an ‘advance’ vehicle control action may indicate a ‘stop’ vehicle control action, a subsequent ‘accelerate’ vehicle control action associated with a defined acceleration rate, and a subsequent ‘stop’ vehicle control action associated with a defined deceleration rate, such that controlling the autonomous vehicle in accordance with the ‘advance’ vehicle control action includes controlling the autonomous vehicle to slowly inch forward a short distance, such as a few inches or a foot.

The AVOMC 4100 may uninstantiate an instance of a SSOCEM 4300. For example, the AVOMC 4100 may identify a distinct set of operative conditions as indicating a distinct vehicle operational scenario for the autonomous vehicle, instantiate an instance of a SSOCEM 4300 for the distinct vehicle operational scenario, monitor the operative conditions, subsequently determine that one or more of the operative conditions has expired, or has a probability of affecting the operation of the autonomous vehicle below a defined threshold, and the AVOMC 4100 may uninstantiate the instance of the SSOCEM 4300.

The AVOMC 4100 may instantiate and uninstantiate instances of SSOCEMs 4300 based on one or more vehicle operational management control metrics, such as an immanency metric, an urgency metric, a utility metric, an acceptability metric, or a combination thereof. An immanency metric may indicate, represent, or be based on, a spatial, temporal, or spatiotemporal distance or proximity, which may be an expected distance or proximity, for the vehicle to traverse the vehicle transportation network from a current location of the vehicle to a portion of the vehicle transportation network corresponding to a respective identified vehicle operational scenario. An urgency metric may indicate, represent, or be based on, a measure of the spatial, temporal, or spatiotemporal distance available for controlling the vehicle to traverse a portion of the vehicle transportation network corresponding to a respective identified vehicle operational scenario. A utility metric may indicate, represent, or be based on, an expected value of instantiating an instance of a SSOCEM 4300 corresponding to a respective identified vehicle operational scenario. An acceptability metric may be a safety metric, such a metric indicating collision avoidance, a vehicle transportation network control compliance metric, such as a metric indicating compliance with vehicle transportation network rules and regulations, a physical capability metric, such as a metric indicating a maximum braking capability of the vehicle, a user defined metric, such as a user preference. Other metrics, or combinations of metrics may be used. A vehicle operational management control metric may indicate a defined rate, range, or limit. For example, an acceptability metric may indicate a defined target rate of deceleration, a defined range of deceleration rates, or a defined maximum rate of deceleration.

A SSOCEM 4300 may include one or more models of a respective distinct vehicle operational scenario. The autonomous vehicle operational management system 4000 may include any number of SSOCEMs 4300, each including models of a respective distinct vehicle operational scenario. A SSOCEM 4300 may include one or more models from one or more types of models. For example, a SSOCEM 4300 may include a Partially Observable Markov Decision Process (POMDP) model, a Markov Decision Process (MDP) model, a Classical Planning model, a Partially Observable Stochastic Game (POSG) model, a Decentralized Partially Observable Markov Decision Process (Dec-POMDP) model, a Reinforcement Learning (RL) model, an artificial neural network model, or any other model of a respective distinct vehicle operational scenario. Each different type of model may have respective characteristics for accuracy and resource utilization. For example, a POMDP model for a defined scenario may have greater accuracy and greater resource utilization than an MDP model for the defined scenario. The models included in a SSOCEM 4300 may be ordered, such as hierarchically, such as based on accuracy. For example, a designated model, such as the most accurate model included in an SSOCEM 4300, may be identified as the primary model for the SSOCEM 4300 and other models included in the SSOCEM 4300 may be identified as secondary models.

In an example, one or more of the SSOCEMs 4300 may include a POMDP model, which may be a single-agent model. A POMDP model may model a distinct vehicle operational scenario, which may include modeling uncertainty, using a set of states (S), a set of actions (A), a set of observations (Ω), a set of state transition probabilities (T), a set of conditional observation probabilities (O), a reward function (R), or a combination thereof. A POMDP model may be defined or described as a tuple <S, A, Ω, T, O, R>.

A state from the set of states (S), may represent a distinct condition of respective defined aspects, such as external objects and traffic control devices, of the operational environment of the autonomous vehicle that may probabilistically affect the operation of the autonomous vehicle at a discrete temporal location. A respective set of states (S) may be defined for each distinct vehicle operational scenario. Each state (state space), from a set of states (S) may include one or more defined state factors. Although some examples of state factors for some models are described herein, a model, including any model described herein, may include any number, or cardinality, of state factors. Each state factor may represent a defined aspect of the respective scenario, and may have a respective defined set of values. Although some examples of state factor values for some state factors are described herein, a state factor, including any state factor described herein, may include any number, or cardinality, of values.

An action from the set of actions (A) may indicate an available vehicle control action at each state in the set of states (S). A respective set of actions may be defined for each distinct vehicle operational scenario. Each action (action space), from a set of actions (A) may include one or more defined action factors. Although some examples of action factors for some models are described herein, a model, including any model described herein, may include any number, or cardinality, of action factors. Each action factor may represent an available vehicle control action, and may have a respective defined set of values. Although some examples of action factor values for some action factors are described herein, an action factor, including any action factor described herein, may include any number, or cardinality, of values.

An observation from the set of observations (52) may indicate available observable, measurable, or determinable data for each state from the set of states (S). A respective set of observations may be defined for each distinct vehicle operational scenario. Each observation (observation space), from a set of observations (52) may include one or more defined observation factors. Although some examples of observation factors for some models are described herein, a model, including any model described herein, may include any number, or cardinality, of observation factors. Each observations factor may represent available observations, and may have a respective defined set of values. Although some examples of observation factor values for some observation factors are described herein, an observation factor, including any observation factor described herein, may include any number, or cardinality, of values.

A state transition probability from the set of state transition probabilities (T) may probabilistically represent changes to the operational environment of the autonomous vehicle, as represented by the set of states (S), responsive to the actions of the autonomous vehicle, as represented by the set of actions (A), which may be expressed as T:S×A×S→[0, 1]. A respective set of state transition probabilities (T) may be defined for each distinct vehicle operational scenario. Although some examples of state transition probabilities for some models are described herein, a model, including any model described herein, may include any number, or cardinality, of state transition probabilities. For example, each combination of a state, an action, and a subsequent state may be associated with a respective state transition probability.

A conditional observation probability from the set of conditional observation probabilities (O) may represent probabilities of making respective observations (52) based on the operational environment of the autonomous vehicle, as represented by the set of states (S), responsive to the actions of the autonomous vehicle, as represented by the set of actions (A), which may be represented as O:A×S×Ω→[0, 1]. A respective set of conditional observation probabilities (O) may be defined for each distinct vehicle operational scenario. Although some examples of state conditional observation probabilities for some models are described herein, a model, including any model described herein, may include any number, or cardinality, of conditional observation probabilities. For example, each combination of an action, a subsequent state, and an observation may be associated with a respective conditional observation probability.

The reward function (R) may determine a respective positive or negative (cost) value that may be accrued for each combination of state and action, which may represent an expected value of the autonomous vehicle traversing the vehicle transportation network from the corresponding state in accordance with the corresponding vehicle control action to the subsequent state, which may be expressed as R:S×A→R.

For simplicity and clarity, the examples of values of a model, such as state factor values or observation factor values, described herein include categorical representations, such as {start, goal} or {short, long}. The categorical values may represent defined discrete values, which may be relative values. For example, a state factor representing a temporal aspect may have values from the set {short, long}; the value ‘short’ may represent discrete values, such as a temporal distance, within, or less than, a defined threshold, such as three seconds, and the value ‘long’ may represent discrete values, such as a temporal distance, of at least, such as equal to or greater than, the defined threshold. Defined thresholds for respective categorical values may be defined relative to associated factors. For example, a defined threshold for the set {short, long} for a temporal factor may be associated with a relative spatial location factor value and another defined threshold for the set {short, long} for the temporal factor may be associated with another relative spatial location factor value. Although categorical representations of factor values are described herein, other representations, or combinations of representations, may be used. For example, a set of temporal state factor values may be {short (representing values of less than three seconds), 4, 5, 6, long (representing values of at least 7 seconds)}.

In some embodiments, such as embodiments implementing a POMDP model, modeling an autonomous vehicle operational control scenario may include modeling occlusions. For example, the operational environment data may include information corresponding to one or more occlusions, such as sensor occlusions, in the operational environment of the autonomous vehicle such that the operational environment data may omit information representing one or more occluded external objects in the operational environment of the autonomous vehicle. For example, an occlusion may be an external object, such as a traffic signs, a building, a tree, an identified external object, or any other operational condition or combination of operational conditions capable of occluding one or more other operational conditions, such as external objects, from the autonomous vehicle at a defined spatiotemporal location. In some embodiments, an operational environment monitor 4200 may identify occlusions, may identify or determine a probability that an external object is occluded, or hidden, by an identified occlusion, and may include occluded vehicle probability information in the operational environment data output to the AVOMC 4100, and communicated, by the AVOMC 4100, to the respective SSOCEMs 4300.

The autonomous vehicle operational management system 4000 may include any number or combination of types of models. For example, the pedestrian-SSOCEM 4310, the intersection-SSOCEM 4320, the lane-change-SSOCEM 4330, the merge-SSOCEM 4340, and the pass-obstruction-SSOCEM 4350 may be POMDP models. In another example, the pedestrian-SSOCEM 4310 may be a MDP model and the intersection-SSOCEM 4320 may be a POMDP model. The AVOMC 4100 may instantiate any number of instances of the SSOCEMs 4300 based on the operational environment data.

Instantiating a SSOCEM 4300 instance may include identifying a model from the SSOCEM 4300, and instantiating an instance of the identified model. For example, a SSOCEM 4300 may include a primary model and a secondary model for a respective distinct vehicle operational scenario, and instantiating the SSOCEM 4300 may include identifying the primary model as a current model and instantiating an instance of the primary model. Instantiating a model may include determining whether a solution or policy is available for the model. Instantiating a model may include determining whether an available solution or policy for the model is partially solved, or is convergent and solved. Instantiating a SSOCEM 4300 may include instantiating an instance of a solution or policy for the identified model for the SSOCEM 4300.

Solving a model, such as a POMDP model, may include determining a policy or solution, which may be a function, that maximizes an accrued reward, which may be determined by evaluating the possible combinations of the elements of the tuple, such as <S, A, Ω, T, O, R>, that defines the model. A policy or solution may identify or output a reward maximized, or optimal, candidate vehicle control action based on identified belief state data. The identified belief state data, which may be probabilistic, may indicate current state data, such as a current set of state values for the respective model, or a probability for the current set of state values, and may correspond with a respective relative temporal location. For example, solving a MDP model may include identifying a state from the set of states (S), identifying an action from the set of action (A), determining a subsequent, or successor, state from the set of states (S) subsequent to simulating the action subject to the state transition probabilities. Each state may be associated with a corresponding utility value, and solving the MDP model may include determining respective utility values corresponding to each possible combination of state, action, and subsequent state. The utility value of the subsequent state may be identified as the maximum identified utility value subject to a reward, or penalty, which may be a discounted reward, or penalty. The policy may indicate an action corresponding to the maximum utility value for a respective state. Solving a POMDP model may be similar to solving the MDP model, except based on belief states, representing probabilities for respective states and subject to observation probabilities corresponding generating observations for respective states. Thus, solving the SSOCEM model includes evaluating the possible state-action-state transitions and updating respective belief states, such as using Bayes rule, based on respective actions and observations.

In some implementations, a model, such as a MDP model or a POMDP model, may reduce the resource utilization associated with solving the corresponding model by evaluating the states, belief states, or both, modeled therein to identify computations corresponding to the respective states, belief states, or both that may be omitted and omitting performing the identified computations, which may include obtaining or maintaining a measure of current quality, such as upper and lower bounds on utility for the respective state, belief state, or both. In some implementations, solving a model may include parallel processing, such as parallel processing using multiple processor cores or using multiple processors, which may include graphics processing units (GPUs). In some implementations, solving a model may include obtaining an approximation of the model, which may improve the efficiency of solving the model.

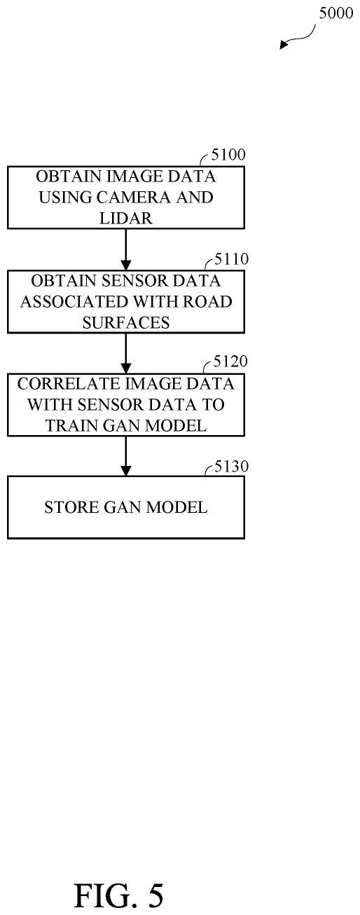

FIG. 5 is a flow diagram of an example of a method 5000 for training a vision-based model for haptic road feel. The vision-based model is trained to turn images of a road into haptic vibrations. The method 5000 may be performed by a vehicle, such as the vehicle 1000 shown in FIG. 1. In this example, the vehicle may be a test vehicle that is configured to traverse the vehicle transportation network under controlled conditions and is not available to consumers. At 5100, the method 5000 includes obtaining image data using a camera and a LIDAR sensor. The image data may be obtained at 800 Hz such that there are at least 800 usable lines in an image per second. In some examples, the image data may be obtained at an average of approximately 1600 Hz to 3200 Hz. In some examples, the image data may be obtained at less than 100 Hz. The image data obtained from the camera may be used to determine a road surface type, such as, for example, asphalt, concrete, snow, ice, leaves, dirt, mud, sand, or another road surface type. The image data obtained from the LIDAR sensor may be used to determine a three-dimensional (3D) surface of the road that shows the granularity of the road, grooves in the road, dips in the road, potholes in the road, or another 3D surface of the road.

The following is an example where the image data is obtained at less than 100 Hz. A minimum allowable rate in terms of time may be set to maintain smoothness at the steering wheel. A minimum rate in terms of distance may be set to accurately model the road surface texture. The fidelity S required to represent the road may be set, for example, at 100 samples per meter (1 cm level fidelity). If a target speed V is represented in m/s, then S×V is the number of samples recorded per second at speed V. Accordingly, at approximately 67 MPH (i.e., 30 m/s), 100 samples/m×30 m/s=3000 Hz. 3000 Hz may be achieved by using a specialized camera that is configured to scan one horizontal line of the road at 3000 Hz. Alternatively, a camera that is configured to scan two (2) lines of the road 1 cm apart at 1500 Hz may be implemented.

Generally,

$$f = \frac{S \times V}{N} ,$$

where N is the number of usable lines in an image, and f represents an actual frame rate of the images. Accordingly, the frame rate and image size can be adjusted to avoid unrealistic frame rates. The benefit of this is that a camera capable of capturing images at approximately 30 frame per second (fps) may be implemented.

The adjustment of the frame rate and image size may be based on sensor size P in pixels, height of mounting H, angle of camera from vertical φ, and camera field of view angle θ. For a small θ, the image may be fairly even, but for larger angles or long distance views, sufficient data must be confirmed. For example, an angle covered per-pixel for a non-distorting lens may be represented as

$${θ}^{′} = \frac{θ}{P} ,$$

where distances D₁′ and D₂′ are different even though θ′ for each distance is the same. An approximation for θ′ provides that

$${{D}_{n}}^{′} \approx \frac{θ′ H}{cos ( φ + {θ}^{′} ( n + \frac{1}{2} ) ) cos ( φ + n {θ}^{′} )}$$

for the nth pixel in the camera (vertically). This can be used to determine that there is at least one pixel per cm (e.g., D′ₙ≤1 cm).

In an example, a 100 pixel tall sensor may have a 10° vertical field of view, and θ′=0.1°=0.002 rad. In this example, the mounting height H of the camera may be 0.3 m and the mounting angle φ may be 45°. The first pixel may have a distance D₁′ of approximately 0.0012 m and the last pixel may have a distance D₁₀₀′ of approximately 0.0018 m. Accordingly, at the start of the sensor, approximately 8 pixels can be binned together to achieve a 1 cm resolution, and approximately 5 pixels can be binned together at the end of the sensor to achieve a 1 cm resolution.

If we have 12 usable lines per frame (e.g., N=12), then

$$f = \frac{10 \times 30}{12} = 250 fps$$

(i.e., 250 Hz). In an example where the sensor is a 300 pixel sensor with a 30° field of view, N is approximately 82. Accordingly,

$$f = \frac{100 \times 30}{82} = 36.6 Hz ,$$

which is within the range of a typical consumer camera. In these examples, the haptic feedback may be output at 800 Hz or more, but the road vibrations may be sensed at approximately 37 Hz. Note that if the vehicle is travelling at less than 0.03 m/s, 800 Hz may not be achieved because at least 22 lines per frame are needed, and the lowest resolution is 0.0012 m. However, at this speed, the driver would not be receiving much feedback in any case, and so the time-rate of haptic feedback could be relaxed without issue.

At 5110, the method 5000 includes obtaining sensor data associated with road surfaces. The sensor data is obtained from one or more sensors, such as a strain sensor, a torque sensor, a wheel speed sensor, a GPS-based speed sensor, a gyroscope sensor, a tire scrub sensor, an anti-roll bar sensor, a strut position sensor, a brake sensor, a weight distribution sensor, or another sensor that can obtain data associated with a road surface. The sensor data is converted to haptic data to communicate vibrations to the driver. In an example, strain sensors may be used to obtain force information associated with the suspension of the vehicle, and torque sensors may be used to obtain force information associated with a steering rack or a steering wheel of the vehicle. In an example, gyroscope sensor movement of an unsprung weight of the suspension may be used to determine the road surface. The gyroscope sensor may also be used to determine an angle of the vehicle as it traverses through the vehicle transportation network. Tire scrub sensors may be used to determine the grip of one or more tires. The anti-roll bar sensor, strut position sensor, or both, can be used to determine strain on the vehicle.

At 5120, the method 5000 includes correlating the image data from the camera and the lidar sensor with the sensor data to train a machine learning model, such as a GAN model. The image data may form a training data set that is associated with different road surface conditions. Correlating the image data from the camera and the lidar sensor with the sensor data includes correlating the haptic data with the image data for different road surface conditions to generate haptic signatures for each of the different road surface conditions. The haptic data may be obtained from one or more vibration sensors on any surface that can be touched by the driver, such as on the steering wheel, accelerator pedal, brake pedal, transmission shifter, seat, or another component of the vehicle. In some examples, a 3D terrain model may be generated based on the LIDAR image data. The sensor data can be correlated with the 3D terrain model to train the GAN model. A speed-related time offset may be implemented to align haptic data and road surface information. A recommendation model may be trained to recognize the correct parameters for each sensor to output the correct pre-recorded haptic signature for different road conditions. The recommendation model may be trained based on the GAN model.

At 5130, the method 5000 includes storing the GAN model, the recommendation model, or both. The GAN model, the recommendation model, or both may be stored in a memory, such as memory 1340 shown in FIG. 1. The GAN model may be stored in the memory of the test vehicle, a production vehicle that is available to the consumer, or both.

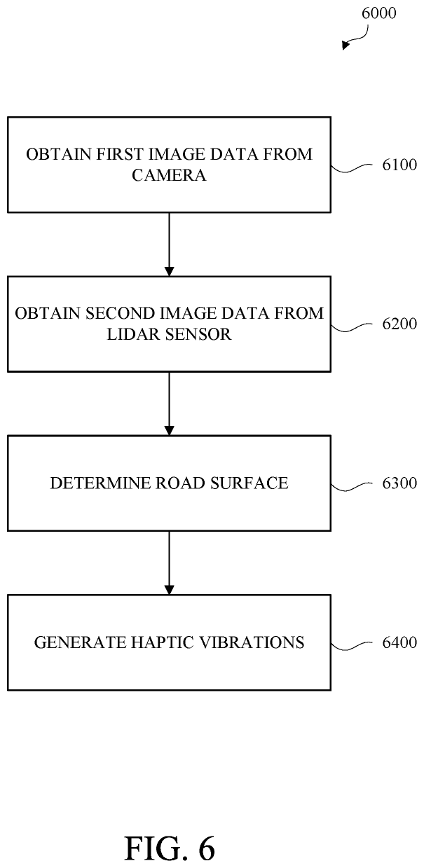

FIG. 6 is a flow diagram of an example of a method 6000 for generating a haptic road feel using a vision-based model. The method 6000 may be performed by a vehicle, such as the vehicle 1000 shown in FIG. 1. In this example, the vehicle may be a production vehicle that is configured to traverse the vehicle transportation network and is available to consumers. At 6100, the method 6000 includes obtaining first image data from a camera. The first image data may be obtained at least at 800 Hz such that there are at least 800 usable lines in an image per second. In some examples, the first image data may be obtained at an average of approximately 1600 Hz to 3200 Hz. The first image data obtained from the camera may be used to determine a road surface type, such as, for example, asphalt, concrete, snow, ice, leaves, dirt, mud, sand, or another road surface type.

At 6200, the method 6000 includes obtaining second image data from a LIDAR sensor. The second image data may be obtained at least at 800 Hz such that there are at least 800 usable lines in an image per second. In some examples, the second image data may be obtained at an average of approximately 1600 Hz to 3200 Hz. The image data obtained from the LIDAR sensor may be used to determine a 3D surface of the road that shows the granularity of the road, grooves in the road, dips in the road, potholes in the road, or another 3D surface of the road.

At 6300, the method 6000 includes determining a road surface. The road surface may be determined based on the first image data and the second image data. The road surface may be determined using a GAN ML model. Determining the road surface may include determining a road surface type, determining a 3D surface of the road, or both. Determining the road surface includes identifying one or more haptic signatures associated with the road surface.

At 6400, the method 6000 includes generating haptic vibrations. The haptic vibrations are generated using one or more vibration motors on any surface that can be touched by the driver, such as on the steering wheel, accelerator pedal, brake pedal, transmission shifter, seat, or another component of the vehicle. The haptic vibrations are generated based on one or more identified haptic signatures of the determined road surface. The haptic vibrations are generated to recreate the road feel of the determined road surface.

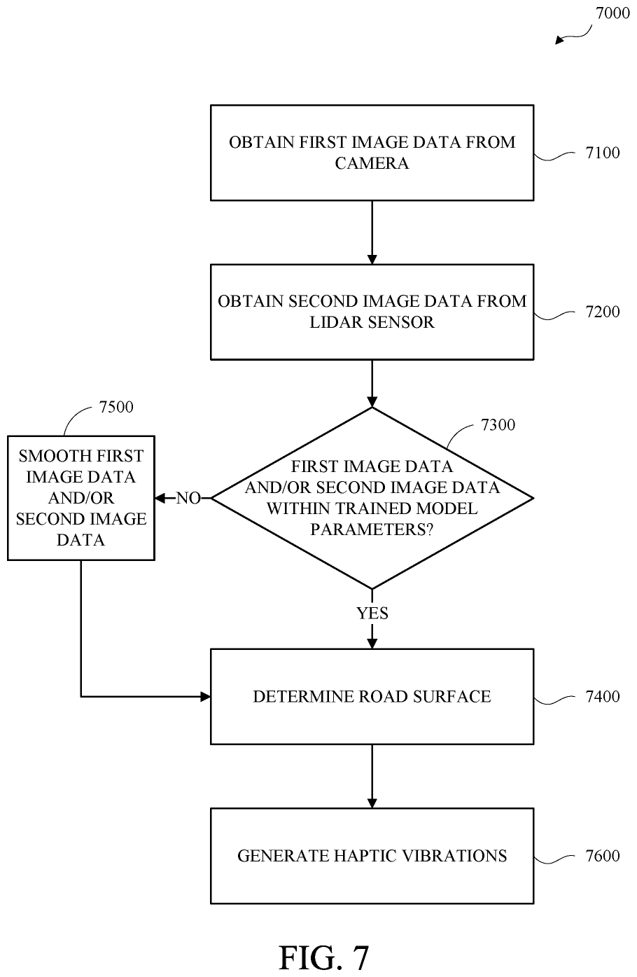

FIG. 7 is a flow diagram of another example of a method 7000 for generating a haptic road feel using a vision-based model. In this example, the vision-based model may be used to turn 3D models of the road surface, by way of smoothing, into haptic vibrations. For example, a 3D surface model such as a terrain model may be generated to create virtual images to fill in if there are gaps in recording actual images. The vision-based model can then use the virtual images and the actual images to generate the haptic road feel. The method 7000 may be performed by a vehicle, such as the vehicle 1000 shown in FIG. 1. In this example, the vehicle may be a production vehicle that is configured to traverse the vehicle transportation network and is available to consumers. At 7100, the method 7000 includes obtaining first image data from a camera. The first image data may be obtained at least at 800 Hz such that there are at least 800 usable lines in an image per second. In some examples, the first image data may be obtained at an average of approximately 1600 Hz to 3200 Hz. The first image data obtained from the camera may be used to determine a road surface type, such as, for example, asphalt, concrete, snow, ice, leaves, dirt, mud, sand, or another road surface type.

At 7200, the method 7000 includes obtaining second image data from a LIDAR sensor. The second image data may be obtained at least at 800 Hz such that there are at least 800 usable lines in an image per second. In some examples, the second image data may be obtained at an average of approximately 1600 Hz to 3200 Hz. The image data obtained from the LIDAR sensor may be used to determine a 3D surface of the road that shows the granularity of the road, grooves in the road, dips in the road, potholes in the road, or another 3D surface of the road.

At 7300, the method 7000 includes determining whether the first image data, the second image data, or both, are within the trained model parameters. An example of when the first image data, the second image data, or both, are outside the trained model parameters may be when the vehicle traverses over a pothole. In this example, a threshold for a maximum allowable rate of change of the suspension may be used to remove harmonic vibrations to generate a realistic road feel. The rate of change of the suspension may be an allowable distance of travel for the suspension. If it is determined that the first image data, the second image data, or both, are within the trained model parameters, the method 7000 includes, at 7400, determining a road surface. The road surface may be determined based on the first image data and the second image data. The road surface may be determined using a GAN ML model. Determining the road surface may include determining a road surface type, determining a 3D surface of the road, or both. Determining the road surface includes identifying one or more haptic signatures associated with the road surface. If it is determined that the first image data, the second image data, or both, are not within the trained model parameters, the method 7000, at 7500, includes smoothing the first image data, the second image data, or both. The smoothing of the first image data, the second image data, or both may be performed when the images are not being obtained quickly enough. In this case, a 3D model is created based on the available images, and then a smoothing technique is used to average the model information between the images.

At 7600, the method 7000 includes generating haptic vibrations. The haptic vibrations may be based on a physics-based model. The physics-based model may be derived from the GAN ML model. The physics of tire interactions with a virtual 3D road surface may be modeled into haptic vibrations to generate the physics-based model. The physics-based model may be based on input data that includes vehicle suspension linkage data, tire data, tire deformation data, and other vehicle data associated with road vibrations. The haptic vibrations are generated using one or more vibration motors on any surface that can be touched by the driver, such as on the steering wheel, accelerator pedal, brake pedal, transmission shifter, seat, or another component of the vehicle. The haptic vibrations are generated based on one or more identified haptic signatures of the determined road surface. The haptic vibrations are generated to recreate the road feel of the determined road surface.

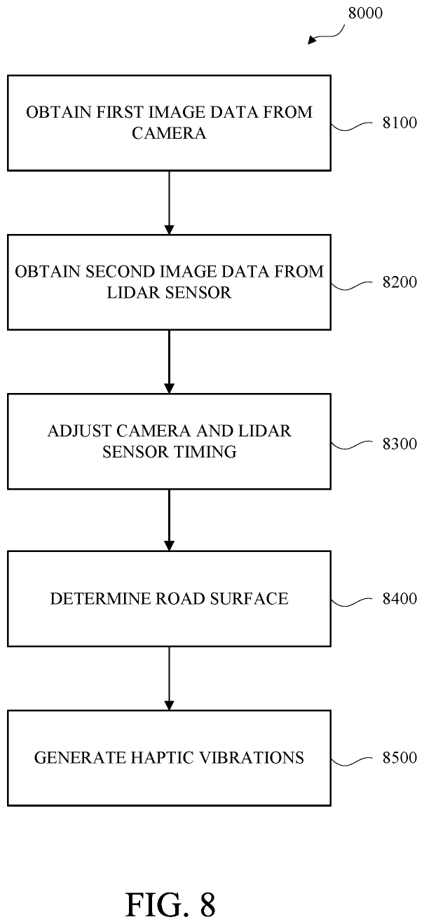

FIG. 8 is a flow diagram of another example of a method for generating a haptic road feel using a vision-based model. The method 8000 may be performed by a vehicle, such as the vehicle 1000 shown in FIG. 1. In this example, the vehicle may be a production vehicle that is configured to traverse the vehicle transportation network and is available to consumers. At 8100, the method 8000 includes obtaining first image data from a camera. The first image data may be obtained at least at 800 Hz such that there are at least 800 usable lines in an image per second. In some examples, the first image data may be obtained at an average of approximately 1600 Hz to 3200 Hz. The first image data obtained from the camera may be used to determine a road surface type, such as, for example, asphalt, concrete, snow, ice, leaves, dirt, mud, sand, or another road surface type.

At 8200, the method 8000 includes obtaining second image data from a LIDAR sensor. The second image data may be obtained at least at 800 Hz such that there are at least 800 usable lines in an image per second. In some examples, the second image data may be obtained at an average of approximately 1600 Hz to 3200 Hz. The image data obtained from the LIDAR sensor may be used to determine a 3D surface of the road that shows the granularity of the road, grooves in the road, dips in the road, potholes in the road, or another 3D surface of the road.

At 8300, the method 8000 includes adjusting the camera and LIDAR sensor timing. The feedback may be increased for small bumps such as the granularity of the road and smoothing large bumps such as potholes in the road. Smoothing large bumps may include activating the suspension of the vehicle. In an example, the timing for obtaining image data from the camera and LIDAR sensor can be adjusted such that it is reduced to create a road feel that is smooth to simulate a luxury driving experience. In another example, the timing for obtaining image data from the camera and LIDAR sensor can be adjusted such that it is increased to create a road feel that is responsive to simulate a sporty driving experience.

At 8400, the method 8000 includes determining a road surface. The road surface may be determined based on the timing-adjusted first image data and the timing-adjusted second image data. The road surface may be determined using a GAN ML model.

Determining the road surface may include determining a road surface type, determining a 3D surface of the road, or both. Determining the road surface includes identifying one or more haptic signatures associated with the road surface.

At 8500, the method 8000 includes generating haptic vibrations. The haptic vibrations may be based on a physics-based model. The physics-based model may be derived from the GAN ML model. The haptic vibrations are generated using one or more vibration motors on any surface that can be touched by the driver, such as on the steering wheel, accelerator pedal, brake pedal, transmission shifter, seat, or another component of the vehicle. The haptic vibrations are generated based on one or more identified haptic signatures of the determined road surface. The haptic vibrations are generated to recreate the road feel of the determined road surface.

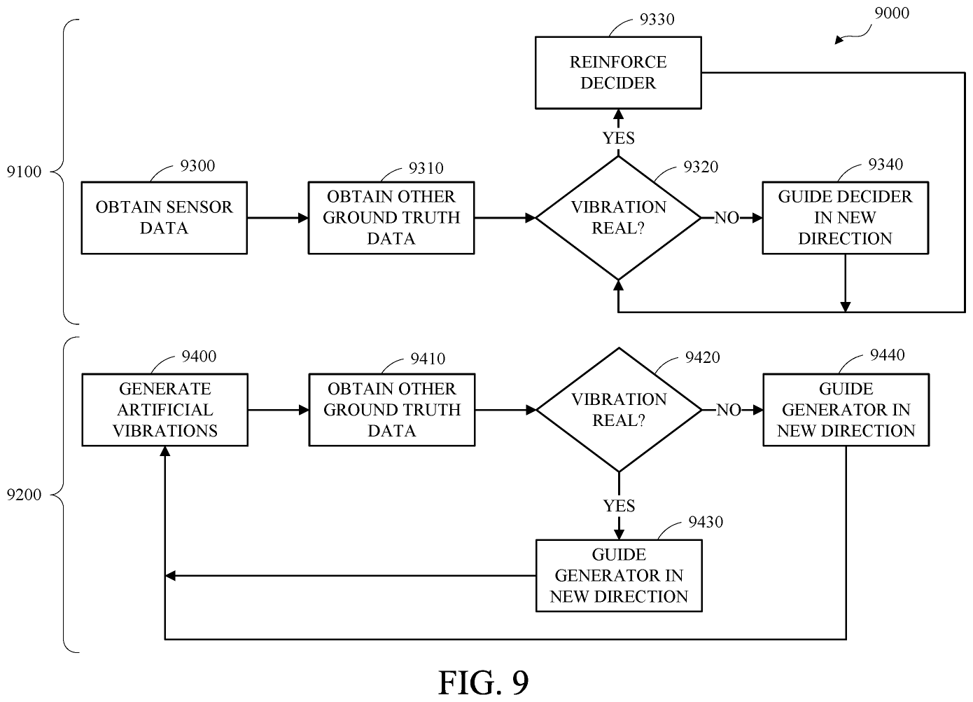

FIG. 9 is a flow diagram of an example of a method 9000 for training a GAN model for haptic road feel. The method 9000 may be performed by a vehicle, such as the vehicle 1000 shown in FIG. 1. In this example, the vehicle may be a test vehicle that is configured to traverse the vehicle transportation network under controlled conditions and is not available to consumers. The method 9000 includes a decider portion 9100 and a generator portion 9200. The decider portion 9100 and the generator portion 9200 are run in parallel. At 9300, the method 9000 includes obtaining sensor data. The sensor data may include vibration data obtained from one or more vibration sensors on any surface that can be touched by the driver, such as on the steering wheel, accelerator pedal, brake pedal, transmission shifter, seat, or another component of the vehicle.

At 9310, the method 9000 includes obtaining other ground truth data. The other ground truth data may include any data or telemetry information that is obtained from any source other than the camera or the LIDAR sensor.

At 9320, the method 9000 includes determining whether the vibration is real. In an example where the GAN model is used to turn images of the road into 3D models of the road surface, the method 9000 may include determining whether the road surface is accurate at 9320, where the GAN model is trained to generate 3D road surfaces rather than vibrations. The GAN model bases the determination of whether the vibration is real on the sensor data and the other ground truth data. If the GAN model determines that the vibration is real, the method 9000, at 9330, includes reinforcing or rewarding the decider for recognizing the vibration. If the GAN model determines that the vibration is not real (i.e., fake), the method 9000, at 9340, guiding the decider in a new direction, for example, by reinforcing or rewarding the generator for the vibration creation. In this example, the decider guessed wrong, therefore the training that led to that decision should be weakened. Randomization may be performed on the decision matrix to lead the decider in novel ways at this decision point. This information may be retested to determine if it results in a correct decision.

At 9400, the method 9000 includes generating artificial vibrations. The artificial vibrations may be generated based on haptic signatures that are stored in a database. An example haptic signature may include a signature for when one or more wheels are approaching their grip limit. A tire scrub vibration may be recorded and replayed when detected. Another example haptic signature may include a signature when low air pressure is detected in one or more wheels. A low air vibration can be played when the when low air pressure is detected. In some examples, the low air vibration may be played in conjunction with a display of an indicator on a display of the vehicle that indicates the detection of low air pressure. The artificial vibrations may be generated using one or more vibration motors on any surface that can be touched by the driver, such as on the steering wheel, accelerator pedal, brake pedal, transmission shifter, seat, or another component of the vehicle.

At 9410, the method 9000 includes obtaining other ground truth data. The other ground truth data may include any data or telemetry information that is obtained from any source other than the camera or the LIDAR sensor.

At 9420, the method 9000 includes determining whether the vibration is real. If it is determined that the vibration is real, the method 9000, at 9430, includes guiding the generator in a new direction, for example, by reinforcing or rewarding the generator for the vibration creation. When the generator is successful at 9430, it is determined that the decider is incorrect. If it is determined that the vibration is not real, the method 9000, at 9440, includes guiding the generator in a new direction, for example, by randomizing an area of the generation decision matrix. When the generator fails at 9440, it is determined that the decider is correct. The GAN model training is complete when less than 50% accuracy is achieved for a predetermined number of trials with fake vibrations.

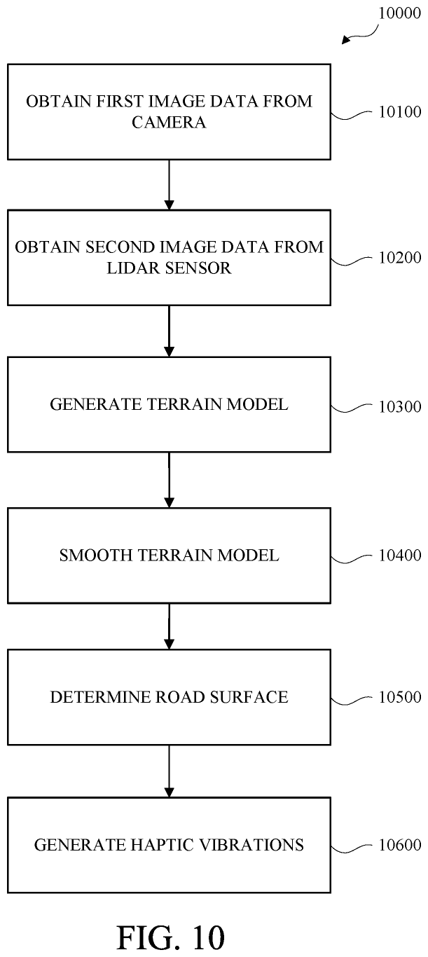

FIG. 10 is a flow diagram of an example of a method for generating a 3D terrain model for haptic road feel. The method 10000 may be performed by a vehicle, such as the vehicle 1000 shown in FIG. 1. In this example, the vehicle may be a production vehicle that is configured to traverse the vehicle transportation network and is available to consumers. At 10100, the method 10000 includes obtaining first image data from a camera. The first image data may be obtained at least at 800 Hz such that there are at least 800 usable lines in an image per second. In some examples, the first image data may be obtained at an average of approximately 1600 Hz to 3200 Hz. The first image data obtained from the camera may be used to determine a road surface type, such as, for example, asphalt, concrete, snow, ice, leaves, dirt, mud, sand, or another road surface type.

At 10200, the method 10000 includes obtaining second image data from a LIDAR sensor. The second image data may be obtained at least at 800 Hz such that there are at least 800 usable lines in an image per second. In some examples, the second image data may be obtained at an average of approximately 1600 Hz to 3200 Hz.

At 10300, the method 10000 includes generating a terrain model. The terrain model may be a 3D model that is based on the image data obtained from the camera, the LIDAR sensor, or both. The 3D model may be a representation of a 3D surface of the road that shows the granularity of the road, grooves in the road, dips in the road, potholes in the road, or another 3D surface of the road.

At 10400, the method 10000 includes smoothing the terrain model. Smoothing the terrain model may include a smoothing of LIDAR imperfections to obtain a smoothed terrain model. The smoothed terrain model may be sampled at as high of a frequency as needed without the dependence on the speed of new image data.

At 10500, the method 10000 includes determining a road surface. The road surface may be determined based on the smoothed terrain model. The road surface may be determined using a GAN ML model. For example, the GAN ML model may determine the road surface using the image data from the camera, the image data from the LIDAR sensor, the terrain model, or any combination thereof. The terrain model may be used when the images are not being provided fast enough, and the terrain model is created to provide such that a constant stream of vibration information can be generated. Determining the road surface may include determining a road surface type, determining a 3D surface of the road, or both. Determining the road surface includes identifying one or more haptic signatures associated with the road surface.

At 10600, the method 10000 includes generating haptic vibrations. The haptic vibrations may be based on a physics-based model. The physics-based model may be derived from the GAN ML model. The haptic vibrations are generated using one or more vibration motors on any surface that can be touched by the driver, such as on the steering wheel, accelerator pedal, brake pedal, transmission shifter, seat, or another component of the vehicle. The haptic vibrations are generated based on one or more identified haptic signatures of the determined road surface. The haptic vibrations are generated to recreate the road feel of the determined road surface. The GAN model may be used to create a custom vibration based on the input data. The haptic signatures may be created by a recommendation model based on non-spatial information.

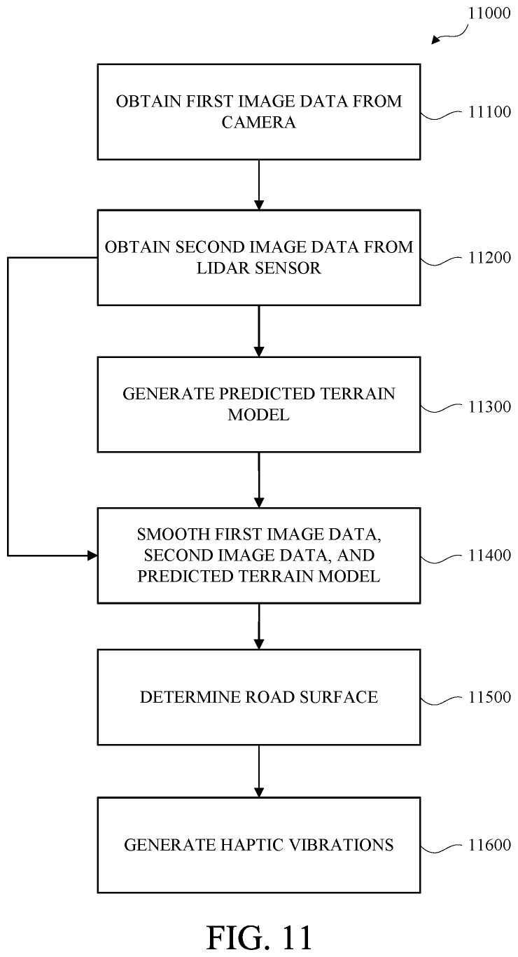

FIG. 11 is a flow diagram of another example of a method for generating a 3D terrain model for haptic road feel. The method 11000 may be performed by a vehicle, such as the vehicle 1000 shown in FIG. 1. In this example, the vehicle may be a production vehicle that is configured to traverse the vehicle transportation network and is available to consumers. At 11100, the method 10000 includes obtaining first image data from a camera. The first image data may be obtained at least at 800 Hz such that there are at least 800 usable lines in an image per second. In some examples, the first image data may be obtained at an average of approximately 1600 Hz to 3200 Hz. The first image data obtained from the camera may be used to determine a road surface type, such as, for example, asphalt, concrete, snow, ice, leaves, dirt, mud, sand, or another road surface type.

At 11200, the method 11000 includes obtaining second image data from a LIDAR sensor. The second image data may be obtained at least at 800 Hz such that there are at least 800 usable lines in an image per second. In some examples, the second image data may be obtained at an average of approximately 1600 Hz to 3200 Hz.

At 11300, the method 11000 includes generating a predicted terrain model. The predicted terrain model may be a 3D model that is based on the image data obtained from the LIDAR sensor. The 3D model may be a predicted representation of a 3D surface of the road that shows the granularity of the road, grooves in the road, dips in the road, potholes in the road, or another 3D surface of the road.

At 11400, the method 11000 includes smoothing the first image data, the second image data, and the predicted terrain model to obtain an adjusted terrain model of the road surface. Smoothing the first image data, the second image data, and the predicted terrain model may include a smoothing of LIDAR imperfections. Smoothing the first image data, the second image data, and the predicted terrain model may include removing potholes (e.g., by filling in geometry), removing road camber, or removing other road surface imperfections. The adjusted terrain model may be sampled at as high of a frequency as needed without the dependence on the speed of new image data. The adjusted terrain model may be used to update the GAN model, the predicted terrain model, or both.

At 11500, the method 11000 includes determining a road surface. The road surface may be determined based on the updated GAN model. Determining the road surface may include determining a road surface type, determining a 3D surface of the road, or both. Determining the road surface includes identifying one or more haptic signatures associated with the road surface.

At 11600, the method 11000 includes generating haptic vibrations. The haptic vibrations may be based on a physics-based model. The physics-based model may be derived from the GAN ML model. The haptic vibrations are generated using one or more vibration motors on any surface that can be touched by the driver, such as on the steering wheel, accelerator pedal, brake pedal, transmission shifter, seat, or another component of the vehicle. The haptic vibrations are generated based on one or more identified haptic signatures of the determined road surface. The haptic vibrations are generated to recreate the road feel of the determined road surface.

As used herein, the terminology “computer” or “computing device” includes any unit, or combination of units, capable of performing any method, or any portion or portions thereof, disclosed herein.

As used herein, the terminology “processor” indicates one or more processors, such as one or more special purpose processors, one or more digital signal processors, one or more microprocessors, one or more controllers, one or more microcontrollers, one or more application processors, one or more Application Specific Integrated Circuits, one or more Application Specific Standard Products; one or more Field Programmable Gate Arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some embodiments, instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method for use in a vehicle, the method comprising:
obtaining first image data from a camera;
obtaining second image data from a light detection and ranging (LIDAR) sensor;
determining a road surface based on the first image data and the second image data using a generative adversarial network (GAN) machine learning (ML) model; and
generating haptic vibrations based on the determined road surface to create a road feel.

2. The method of claim 1, further comprising:
adjusting a timing of the first image data such that the road feel created is smooth.

3. The method of claim 1, further comprising:
adjusting a timing of the first image data such that the road feel created is responsive.

4. The method of claim 1, wherein the haptic vibrations are generated on a steering wheel of the vehicle, a pedal of the vehicle, a seat of the vehicle, or a gear shifter of the vehicle.

5. The method of claim 1, further comprising:
obtaining sensor data from one or more sensors of a test vehicle;
obtaining third image data associated with a camera image of a training data set;
obtaining fourth image data associated with a LIDAR image of the training data set; and
correlating the sensor data with the third image data and the fourth image data to train the GAN ML model.

6. The method of claim 5, wherein the third image data and the fourth image data are obtained at 800 Hz.

7. The method of claim 5, further comprising:
generating a three-dimensional (3D) terrain model based on the LIDAR image; and
correlating the sensor data with the 3D terrain model to train the GAN ML model.

8. A vehicle, comprising:
a camera configured to capture first image data associated with a road surface;
a light detection and ranging (LIDAR) sensor configured to capture second image data associated with the road surface; and
a processor configured to:
determine the road surface based on the first image data and the second image data based on a generative adversarial network (GAN) machine learning (ML) model; and
generate haptic vibrations based on the determined road surface to create a road feel.

9. The vehicle of claim 8, wherein the processor is configured to reduce a timing of the first image data such that the road feel created is smooth.

10. The vehicle of claim 8, wherein the processor is configured to increase a timing of the first image data such that the road feel created is responsive.

11. The vehicle of claim 8, wherein the processor is configured to generate the haptic vibrations on a steering wheel of the vehicle, a pedal of the vehicle, a seat of the vehicle, or a gear shifter of the vehicle.

12. The vehicle of claim 8, wherein the processor is further configured to:
obtain sensor data from one or more sensors;
obtain third image data associated with a camera image of a training data set;
obtain fourth image data associated with a LIDAR image of the training data set; and
correlate the sensor data with the third image data and the fourth image data to train the GAN ML model.

13. The vehicle of claim 12, wherein the processor is configured to obtain the third image data and the fourth image data at a minimum of 800 Hz.

14. The vehicle of claim 12, wherein the processor is further configured to:
generate a three-dimensional (3D) terrain model based on the LIDAR image; and
correlate the sensor data with the 3D terrain model to train the GAN ML model.

15. A non-transitory computer-readable medium comprising instructions stored in a memory, that when executed by a processor, cause the processor to perform operations comprising:
obtaining first image data from a camera;
obtaining second image data from a light detection and ranging (LIDAR) sensor;
determining a road surface based on the first image data and the second image data using a generative adversarial network (GAN) machine learning (ML) model; and
transmitting a signal to a haptic motor on a vehicle component to create a road feel, wherein the signal is based on the determined road surface.

16. The non-transitory computer-readable medium of claim 15, wherein the processor is further configured to perform operations comprising:
reducing a timing of the first image data such that the road feel created is smooth.

17. The non-transitory computer-readable medium of claim 15, wherein the processor is further configured to perform operations comprising:
increasing a timing of the first image data such that the road feel created is responsive.

18. The non-transitory computer-readable medium of claim 15, wherein the vehicle component is a steering wheel, a pedal, a seat, or a gear shifter.

19. The non-transitory computer-readable medium of claim 15, wherein the processor is further configured to perform operations comprising:
obtaining sensor data from one or more sensors of a test vehicle;
obtaining third image data associated with a camera image of a training data set;
obtaining fourth image data associated with a LIDAR image of the training data set; and
correlating the sensor data with the third image data and the fourth image data to train the GAN ML model.

20. The non-transitory computer-readable medium of claim 19, wherein the processor is further configured to perform operations comprising:
generating a three-dimensional (3D) terrain model based on the LIDAR image; and
correlating the sensor data with the 3D terrain model to train the GAN ML model.
